(19) United States
(12) Patent Application Publication
(10) Pub. No.: US 2016/0222702 A1
(43) Pub. Date: Aug. 4, 2016

(54) OPENING/CLOSING MEMBER OPENING/CLOSING APPARATUS

(71) Applicant: Aisin Seiki Kabushiki Kaisha, Kariya-shi (JP)

(72) Inventors: Takaaki KOIZUMI, Kariya-shi (JP); Takehiro TABATA, Kariya-shi (JP); Masahiro HAGIMOTO, Nagoya-shi (JP)

(73) Assignee: Aisin Seiki Kabushiki Kaisha, Kariya-shi (JP)

(21) Appl. No.: 15/012,932

(22) Filed: Feb. 2, 2016

(30) Foreign Application Priority Data
Feb. 2, 2015 (JP) 2015-018474

(51) Int. Cl. E05B 81/76; E05B 85/10; E05B 81/64; E05B 81/04

(52) U.S. Cl. CPC E05B 81/76; E05B 81/04; E05B 85/107; E05B 81/64

(57) ABSTRACT

An opening/closing member opening/closing apparatus includes: an operation handle including a first section thick in a normal direction to a surface on the front side and in which a turning shaft is disposed, and a grip section formed of a second section thinner than the first section on the front side, configured to be supported in a turning manner by a base member disposed in an opening/closing member, and able to shift between an accommodated position and a projecting position; a first sensor section detecting an operation through which the opening/closing member enters into an unlocked state and disposed in the grip section; and a second sensor section detecting an operation through which the opening/closing member enters into a locked state and disposed in the operation handle so as not to be overlapped with the grip section in a side view.

### CROSS REFERENCE TO RELATED APPLICATIONS

This application is based on and claims priority under 35 U.S.C. §119 to Japanese Patent Application 2015-018474, filed on Feb. 2, 2015, the entire contents of which are incorporated herein by reference.

### TECHNICAL FIELD

This disclosure relates to an opening/closing member opening/closing apparatus.

### BACKGROUND DISCUSSION

Recently, a flush surface has been a trend in automobile design. A surface which is flush means an even surface formed without unevenness or a gap in a body surface or the like. The flush surface causes air resistance of a body to be reduced, and thus high-speed performance, low fuel consumption performance, or the like can be improved. In addition, the flush surface contributes to reduction of wind noise during driving of an automobile or improvement in design.

It is preferable that the flush surface is also formed on an operation handle, which performs an opening/closing operation of a door. International Publication No. WO 2012/175647, specification of US 2014/0000167A, Japanese Patent No. 3165570, and Japanese Patent No. 5191157 (References 1 to 4) disclose operation handles on which the flush surface is formed. References 1 and 2 disclose technology in which a door is locked and unlocked by using the operation handle.

However, with the technology disclosed in References 1 and 2, there is a concern that an operation will be incorrectly performed when an operation is performed to lock and unlock the door.

### SUMMARY

Thus, a need exists for an opening/closing member opening/closing apparatus which is not suspectable to the drawback mentioned above.

An aspect of this disclosure provides an opening/closing member opening/closing apparatus including: an operation handle that includes a first section, which is thick in a normal direction to a surface on the front side and in which a turning shaft is disposed, and a grip section formed of a second section which is thinner than the first section in the normal direction to the surface on the front side, that is configured to be supported in a turning manner by a base member disposed in an opening/closing member, and that is able to shift between an accommodated position, at which the grip section is in a state of being accommodated in an accommodation section formed in the base member, and a projecting position, at which the grip section is in a state of projecting from the accommodation section; a first sensor section that detects an operation through which the opening/closing member enters into an unlocked state and that is disposed in the grip section; and a second sensor section that detects an operation through which the opening/closing member enters into a locked state and that is disposed in the operation handle so as not to be overlapped with the grip section in a side view in the normal direction to the surface on the front side of the operation handle.

### BRIEF DESCRIPTION OF THE DRAWINGS

The foregoing and additional features and characteristics of this disclosure will become more apparent from the following detailed description considered with the reference to the accompanying drawings, wherein:

FIG. 1 is a block diagram illustrating an opening/closing member opening/closing apparatus according to an embodiment disclosed here;

FIGS. 2A and 2B are a plan view and a side view of an operation handle of the opening/closing member opening/closing apparatus according to the embodiment disclosed here;

FIGS. 3A and 3B are a plan view and a side view of an internal configuration of the operation handle of the opening/closing member opening/closing apparatus according to the embodiment disclosed here;

FIGS. 4A and 4B are perspective views illustrating a state in which the operation handle is accommodated in an accommodation section;

FIGS. 5A and 5B are side views illustrating the state in which the operation handle is accommodated in the accommodation section;

FIGS. 6A and 6B are plan views illustrating the state in which the operation handle is accommodated in the accommodation section;

FIGS. 7A and 7B are perspective views illustrating a state in which a grip section of the operation handle projects from the accommodation section;

FIGS. 8A and 8B are side views illustrating the state in which the grip section of the operation handle projects from the accommodation section;

FIGS. 9A and 9B are plan views illustrating the state in which the grip section of the operation handle projects from the accommodation section;

FIG. 10 is a plan view illustrating a state in which the grip section of the operation handle is gripped by an occupant or the like;

FIG. 11 is a flowchart illustrating an operation of the opening/closing member opening/closing apparatus according to the embodiment disclosed here;

FIG. 12 is a flowchart illustrating another operation of the opening/closing member opening/closing apparatus according to the embodiment disclosed here;

FIG. 13 is a flowchart illustrating still another operation of the opening/closing member opening/closing apparatus according to the embodiment disclosed here;

FIGS. 14A and 14B are a plan view and a side view illustrating an operation handle of an opening/closing member opening/closing apparatus according to Modification Example 1 of an embodiment disclosed here;

FIGS. 15A and 15B are a plan view and a side view illustrating an operation handle of an opening/closing member opening/closing apparatus according to Modification Example 2 of an embodiment disclosed here;

FIGS. 16A and 16B are plan views illustrating a state in which a grip section of the operation handle projects from an accommodation section; and

FIG. 17 is a plan view illustrating a state in which the grip section of the operation handle is gripped by an occupant or the like.

### DETAILED DESCRIPTION

### Embodiment

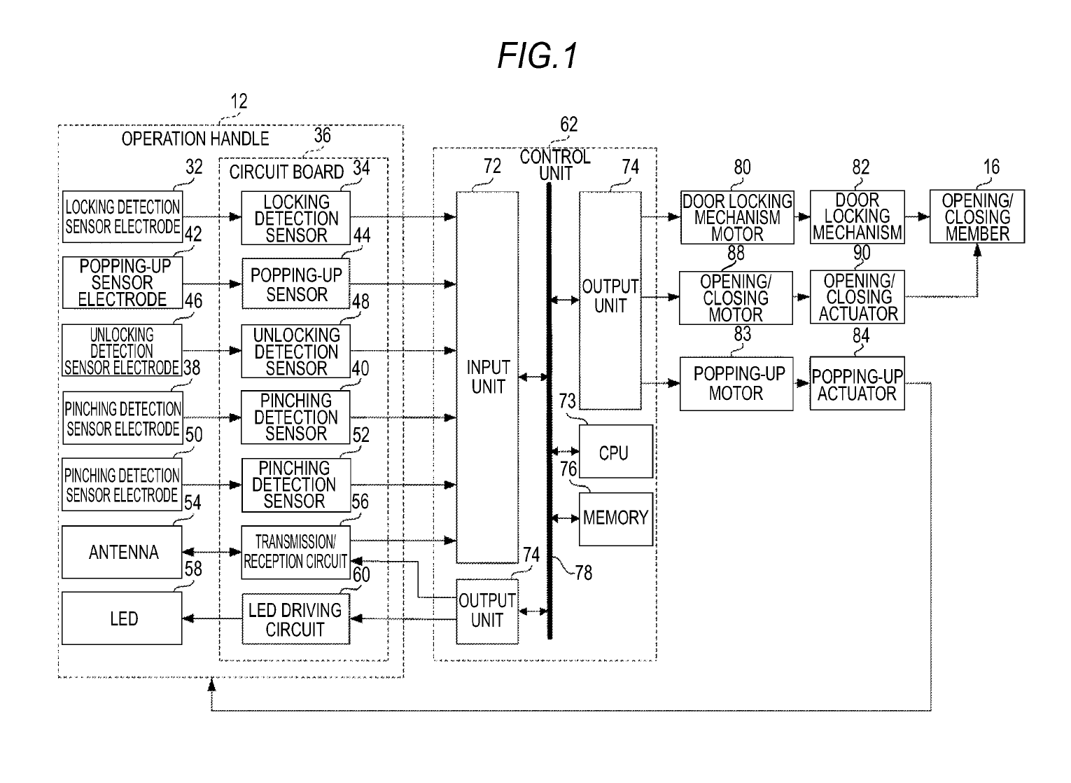

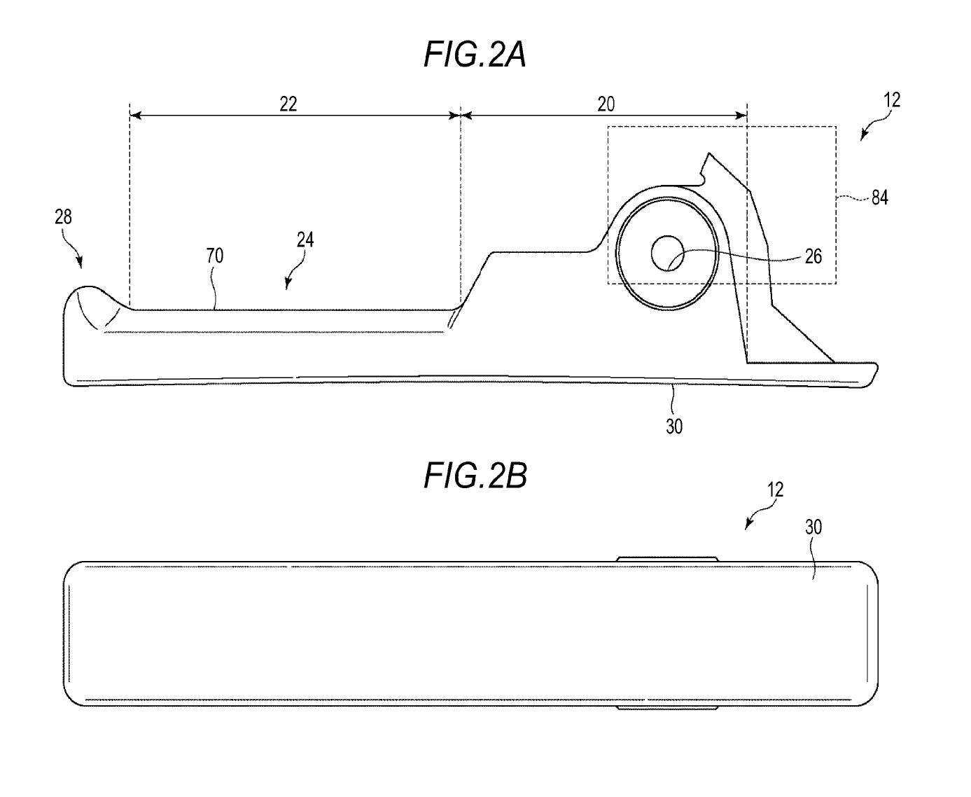

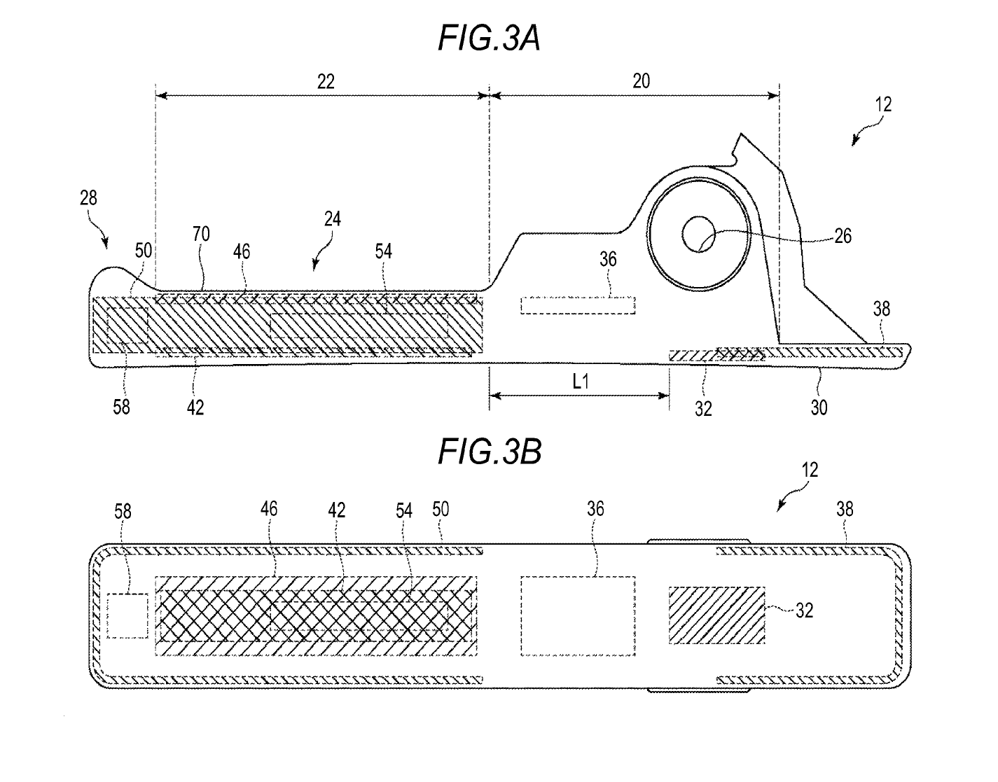

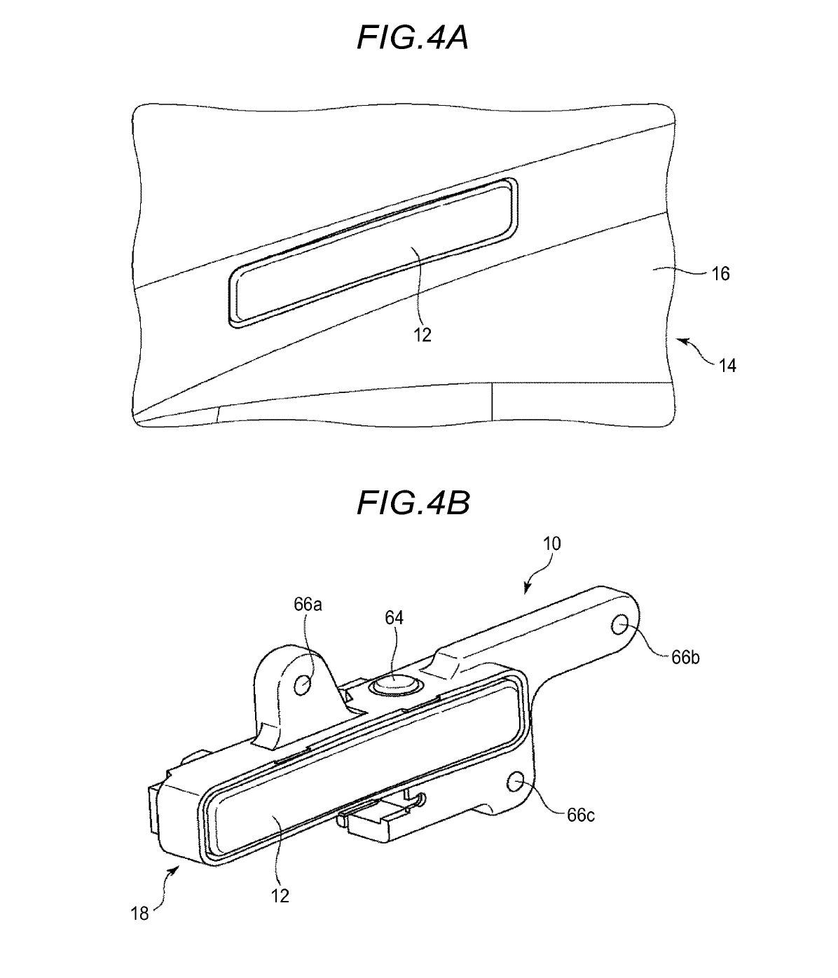

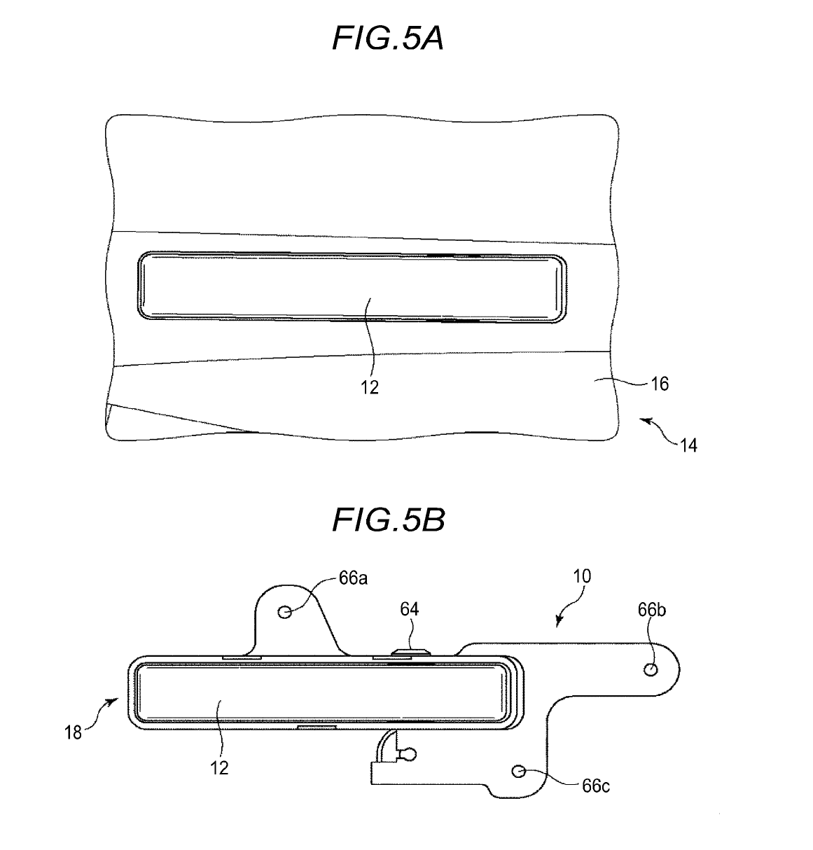

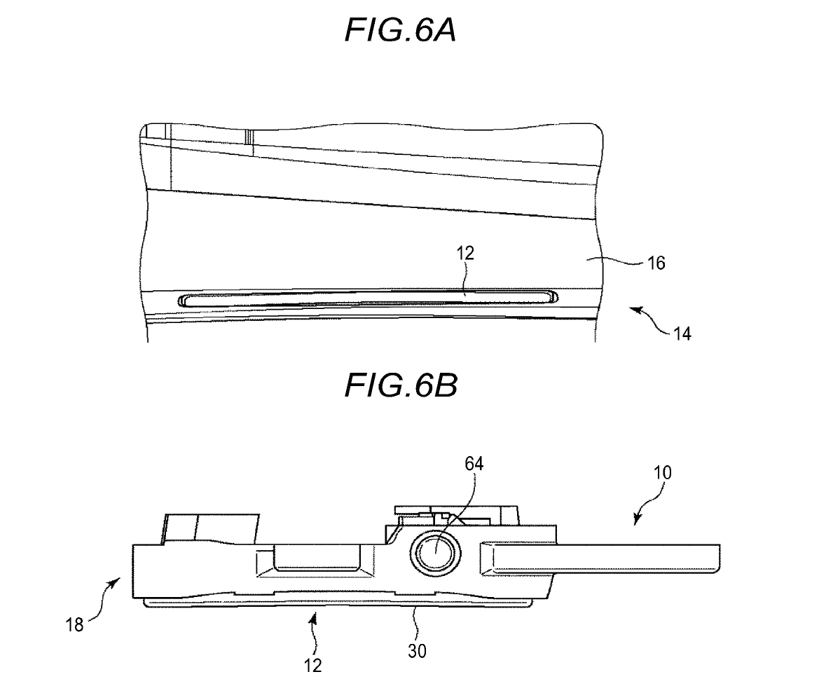

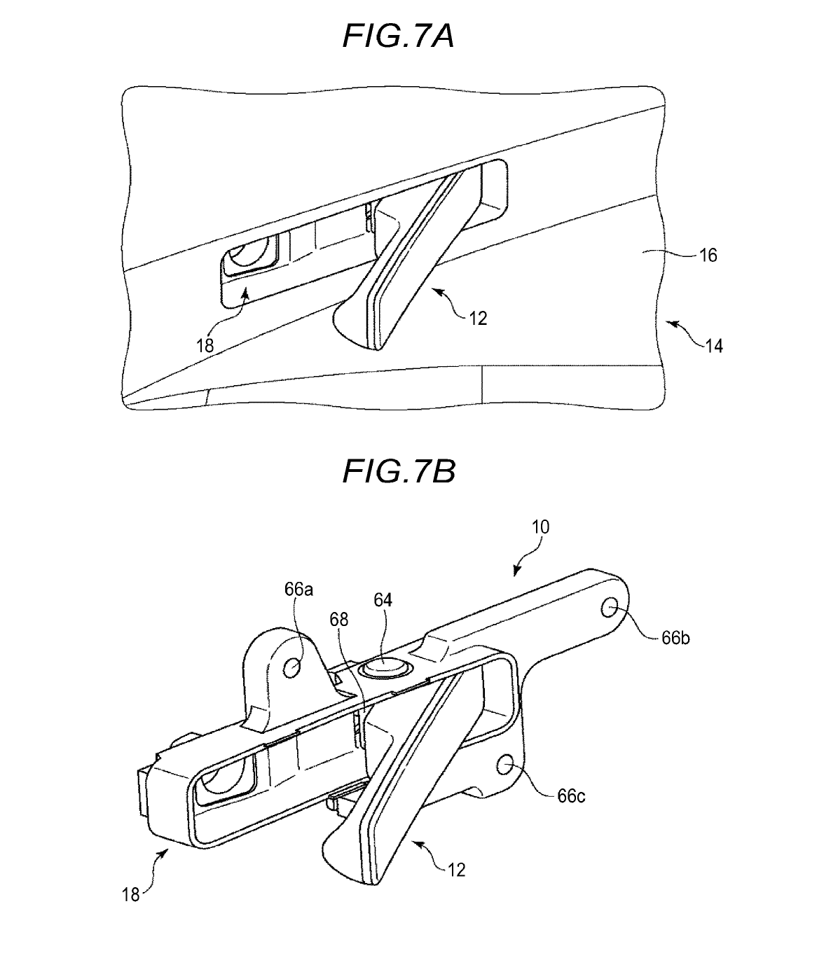

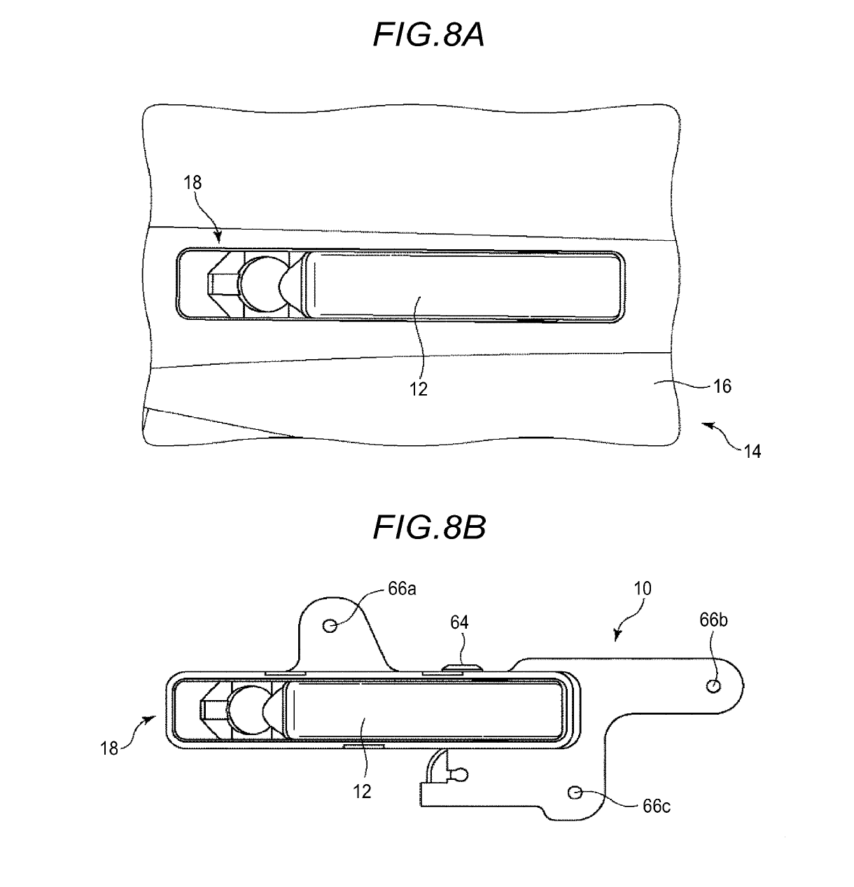

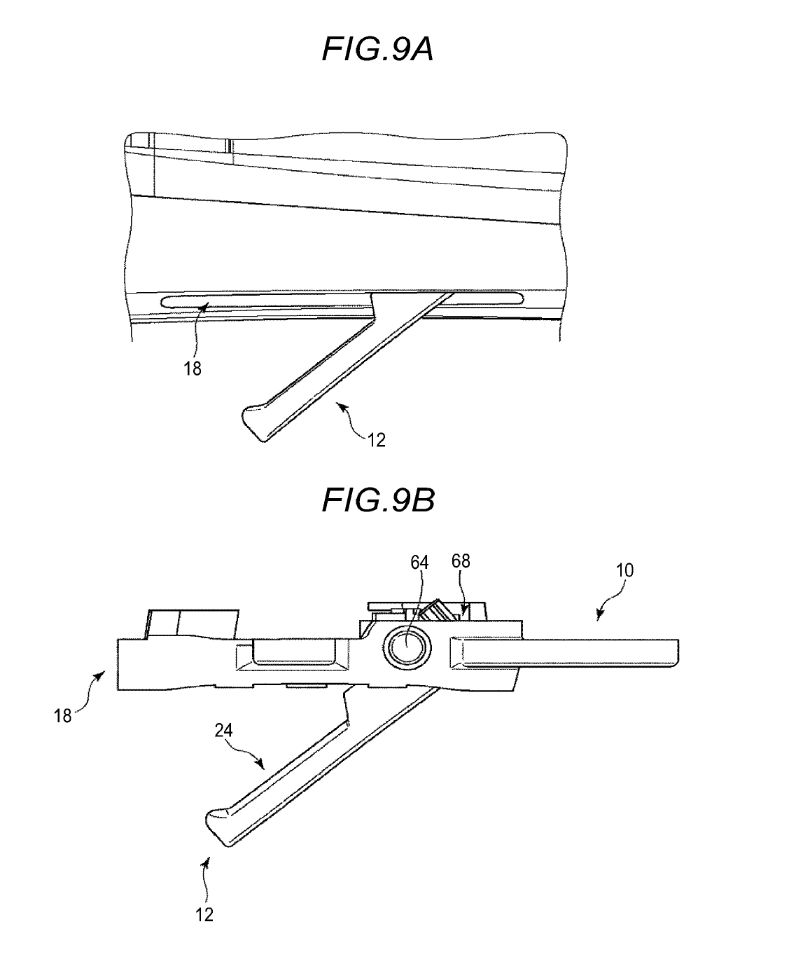

An opening/closing member opening/closing apparatus according to an embodiment is described with reference to the drawings. FIG. 1 is a block diagram illustrating the opening/closing member opening/closing apparatus according to the embodiment. FIGS. 2A and 2B are a plan view and a side view of the operation handle of the opening/closing member opening/closing apparatus according to the embodiment; FIG. 2A is the plan view and FIG. 2B is the side view. FIGS. 3A and 3B are a plan view and a side view of an internal configuration of the operation handle of the opening/closing member opening/closing apparatus according to the embodiment; FIG. 3A is the plan view and FIG. 3B is the side view. FIGS. 4A and 4B are perspective views illustrating a state in which the operation handle is accommodated in an accommodation section. FIGS. 5A and 5B are side views illustrating the state in which the operation handle is accommodated in the accommodation section. FIGS. 6A and 6B are plan views illustrating the state in which the operation handle is accommodated in the accommodation section. FIGS. 7A and 7B are perspective views illustrating a state in which a grip section of the operation handle projects from the accommodation section. FIGS. 8A and 8B are side views illustrating the state in which the grip section of the operation handle projects from the accommodation section. FIGS. 9A and 9B are plan views illustrating the state in which the grip section of the operation handle projects from the accommodation section. FIGS. 4A, 5A, 6A, 7A, 8A, and 9A illustrate a state in which the opening/closing member opening/closing apparatus according to the embodiment is attached to a vehicle and FIGS. 4B, 5B, 6B, 7B, 8B, and 9B illustrate a state in which a base member and the operation handle of the opening/closing member opening/closing apparatus according to the embodiment is detached from the vehicle.

As illustrated in FIGS. 4A to 9B, the opening/closing member opening/closing apparatus according to the embodiment includes an operation handle 12 and a base member 10 that supports the operation handle 12 in a turning manner. In addition, as illustrated in FIG. 1, the opening/closing member opening/closing apparatus according to the embodiment further includes a control unit 62 that performs various types of control in response to operations performed through the operation handle 12 by an occupant or the like, particularly, an electronic control unit (ECU) 62.

An accommodation section 18, which can accommodate the operation handle 12, is provided in the base member 10. A turning shaft inserting hole (not illustrated), into which a turning shaft 64 for supporting, in a turning manner, the operation handle 12 is inserted, is formed in the top and under surfaces of the accommodation section 18. The turning shaft inserting hole is formed at a portion between an end portion of the accommodation section 18 on one side (right-hand side on the paper surface in FIGS. 9A and 9B) in its longitudinal direction and a central portion of the accommodation section 18 in the longitudinal direction. An opening 68 is formed on the back surface side on the one side (right-hand side on the paper surface in FIGS. 9A and 9B) of the accommodation section 18 in the longitudinal direction. The opening 68 is provided to enable the operation handle 12 to turn such that one side (right-hand side on the paper surface in FIGS. 9A and 9B) of the operation handle 12 in its longitudinal direction does not come into contact with the back surface side of the accommodation section 18, when the operation handle 12 is caused to turn. As a material of the base member 10, for example, a resin or the like is used.

As illustrated in FIGS. 2A and 2B, the operation handle (operation lever or door handle) 12 is formed to have a stick shape as a whole. A first section (thick section) 20, which is relatively thick in a normal direction to a surface 30 of the operation handle 12 on its front side, is formed on the one side (right-hand side on the paper surface in FIGS. 2A and 2B) of the operation handle 12 in the longitudinal direction. A second section (thin section) 22, which is relatively thin in the normal direction to the surface 30 of the operation handle 12 on the front side, is formed on the other side (left-hand side on the paper surface in FIGS. 2A and 2B) of the operation handle 12 in the longitudinal direction. As a material of the operation handle 12, for example, a resin or the like is used.

A turning shaft inserting hole 26, into which the turning shaft 64 is inserted, is formed in the first section 20 positioned on the one side (right-hand side on the paper surface in FIGS. 2A and 2B) of the operation handle 12 in the longitudinal direction. The turning shaft inserting hole 26 is positioned in a portion between an end portion of the operation handle 12 on the one side (right-hand side on the paper surface in FIGS. 2A and 2B) in the longitudinal direction and the central portion of the operation handle 12 in the longitudinal direction. The position of the turning shaft inserting hole 26 formed in the operation handle 12 corresponds to the position of the turning shaft inserting hole formed in the base member 10.

The second section 22 positioned on the other side (left-hand side on the paper surface in FIGS. 2A and 2B) of the operation handle 12 in the longitudinal direction is a grip section 24 as a section which is gripped with a hand 66 by an occupant or the like. A boundary between the second section 22 and the first section 20 is an end portion of the grip section 24 on one side in its longitudinal direction. A portion 28, which is thicker than the grip section 24 in the normal direction to the surface 30 of the operation handle 12 on the front side, is formed at an end portion of the grip section 24 on the other side in the longitudinal direction. In this manner, the thickness of the operation handle 12 is changed in the normal direction to the surface 30 of the operation handle 12 on the front side, and thereby the grip section 24 is demarcated.

As illustrated in FIGS. 7A and 7B, the turning shaft 64 is inserted into the turning shaft inserting hole 26 formed in the operation handle 12 and the turning shaft inserting hole formed in the base member 10. As the turning shaft 64, for example, a bolt or the like is used. The operation handle 12 is supported in a turning manner by the base member 10 through the turning shaft 64.

As illustrated in FIGS. 7A and 7B, bolt inserting holes 66a to 66c, which fix the base member 10 to an opening/closing member (door) 16 using a bolt (not illustrated), are formed in the base member 10. The base member 10 is attached to an interior side of the opening/closing member 16 provided in a vehicle (vehicle body, body) 14 using a bolt. In other words, the base member 10, which supports the operation handle 12 in a turning manner, is disposed in the opening/closing member 16.

As illustrated in FIGS. 4A to 9B, the operation handle 12 can shift between an accommodated position, at which the grip section 24 is in a state of being accommodated in the accommodation section 18, and a projecting position, at which the grip section 24 is in a state of projecting from the accommodation section 18. The projecting of the grip section 24 from the accommodation section 18 is referred to as popping-up. The popping-up of the operation handle 12 is performed by using a popping-up actuator 84 (refer to FIGS. 1 to 2B). When the operation handle 12 is accommodated in the accommodation section 18, the external appearance of the vehicle 14 is as illustrated in FIGS. 4A to 6B (accommodated position). When the grip section 24 of the operation handle 12 projects from the accommodation section 18, the external appearance of the vehicle 14 is as illustrated in FIGS. 7A to 9B (projecting position). When the operation handle 12 is accommodated in the accommodation section 18, the surface 30 of the operation handle 12 on the front side is positioned substantially as an extended surface of the surface of the opening/closing member 16 on its front side. Therefore, a flush surface of the vehicle 14 can be realized.

As illustrated in FIGS. 3A and 3B, a sensor section (detection section, detection region, and sensing area) 32 for detecting locking is disposed on the one side (right-hand side on the paper surface in FIGS. 3A and 3B) of the operation handle 12 in the longitudinal direction. The sensor section for detecting locking (locking detection sensor section) 32 is provided to detect an operation by an occupant or the like, through which the opening/closing member 16 enters into a locked state. The operation by an occupant or the like, through which the opening/closing member 16 enters into the locked state, is performed by touching the locking detection sensor section 32 with a part of a hand 66 of the occupant or the like. The locking detection sensor section 32 is disposed in the first section 20 positioned on the one side (right-hand side on the paper surface in FIGS. 3A and 3B) of the operation handle 12 in the longitudinal direction. The locking detection sensor section 32 is disposed so as not to be overlapped with the grip section 24 in a side view in the normal direction to the surface 30 of the operation handle 12 on the front side. In other words, when the operation handle 12 is viewed in the normal direction to the surface 30 of the operation handle 12 on the front side, the locking detection sensor section 32 is disposed so as not to be overlapped with the grip section 24. The grip section 24 and the locking detection sensor section 32 are not overlapped in the side view in the normal direction to the surface 30 of the operation handle 12 on the front side such that a part of the hand 66 of the occupant or the like is prevented from touching the locking detection sensor section 32 by error, when the occupant or the like grips the grip section 24. The locking detection sensor section 32 is disposed to detect an operation by the occupant or the like on the surface 30 of the operation handle 12 on the front side. Accordingly, when a part of the hand 66 of the occupant or the like touches the surface 30 of the operation handle 12 on the front side in a section in which the locking detection sensor section 32 is disposed, a locking detection sensor 34 (refer to FIG. 1) reacts.

The locking detection sensor section 32 is configured to have, for example, a sensor electrode for detecting locking (locking detection sensor electrode). Since the locking detection sensor section 32 is configured to have the locking detection sensor electrode, the same reference sign 32 is assigned to the locking detection sensor section and the locking detection sensor electrode. The locking detection sensor electrode 32 is electrically connected to the locking detection sensor 34 (refer to FIG. 1). The locking detection sensor (locking detection sensor element) 34 is disposed, for example, in a circuit board 36. The circuit board 36 is accommodated, for example, in the first section 20 positioned on the one side (right-hand side on the paper surface in FIGS. 3A and 3B) of the operation handle 12 in the longitudinal direction. As the locking detection sensor 34, for example, a capacitance type sensor or, more specifically, a self-capacitance type sensor can be used.

The locking detection sensor section 32 is set in the operation handle 12. When the hand 66 of the occupant or the like does not touch the locking detection sensor section 32, but touches the surface 30 of the operation handle 12 on the front side in a section in which the locking detection sensor section 32 is set, the locking detection sensor 34 can react. The locking detection sensor section 32 means a section in which the locking detection sensor 34 can react to an operation by the occupant or the like.

When a human appendage or an object does not come into contact with the surface 30 of the operation handle 12 on the front side in the section in which the locking detection sensor section 32 is set, an output of the locking detection sensor 34 indicates a state of “non-detection”. When a human appendage or an object comes into contact with the surface 30 of the operation handle 12 on the front side in the section in which the locking detection sensor section 32 is set, the output of the locking detection sensor 34 indicates a state of “detection”.

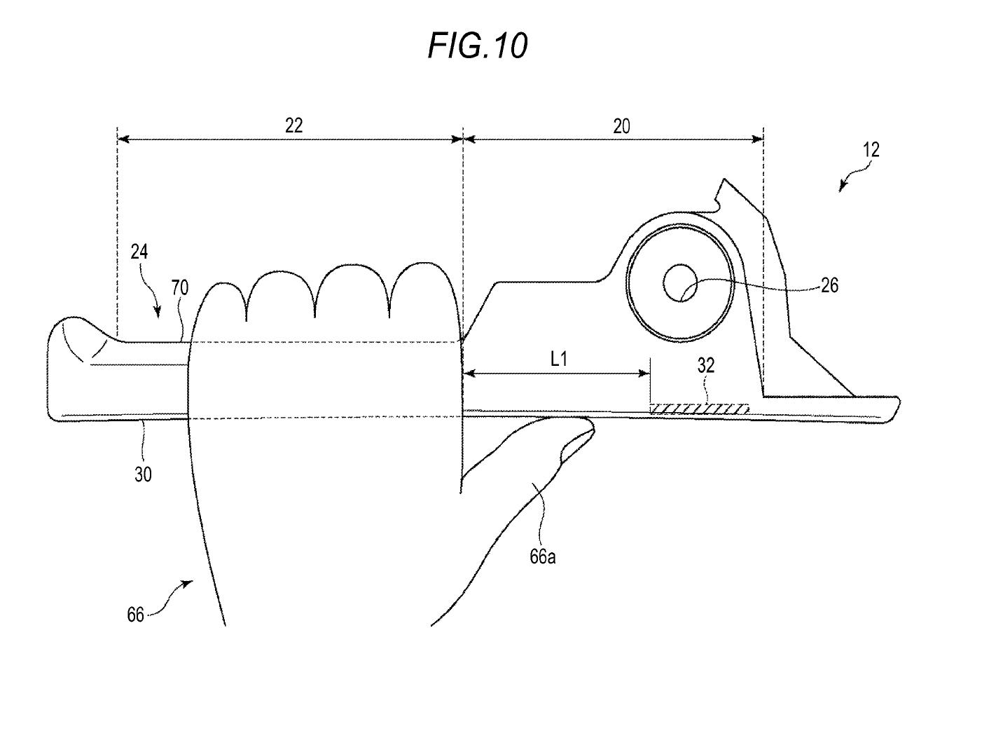

FIG. 10 is a plan view illustrating a state in which the grip section of the operation handle is gripped by an occupant or the like. In a case where the grip section 24 and the locking detection sensor section 32 are overlapped in the side view in the normal direction to the surface 30 of the operation handle 12 on the front side, a part of the hand 66 of the occupant or the like is likely to touch the locking detection sensor section 32, when the occupant or the like grips the grip section 24. In the case where a part of the hand 66 of the occupant or the like touches the locking detection sensor section 32, the locked state of the opening/closing member 16 is fulfilled. In order to prevent a part of the hand 66 of the occupant or the like from touching the locking detection sensor section 32 by error, it is preferable that the locking detection sensor section 32 is disposed at a position at which a part of the hand 66 of the occupant or the like is unlikely to touch the locking detection sensor section 32, when the occupant or the like grips the grip section 24. Hence, in the embodiment, the locking detection sensor section 32 is disposed so as not to be overlapped with the grip section 24 in the side view in the normal direction to the surface 30 of the operation handle 12 on the front side.

In a case where a distance L1 between the end portion (boundary between the first section 20 and the second section 22) of the grip section 24 on the one side in the longitudinal direction and the locking detection sensor section 32 is relatively short, a thumb 66a of the occupant or the like is likely to touch the locking detection sensor section 32 when the occupant or the like grips the grip section 24. When it is taken into account that the thumb 66a of the occupant or the like is reliably prevented from touching the locking detection sensor section 32 when the occupant or the like grips the grip section 24, it is preferable that the distance L1 between the end portion (boundary between the first section 20 and the second section 22) of the grip section 24 on the one side in the longitudinal direction and the locking detection sensor section 32 is set to be long. Specifically, it is preferable that the distance L1 between the end portion of the grip section 24 on the one side in the longitudinal direction and the locking detection sensor section 32 is, for example, equal to or greater than 30 mm. When the distance L1 between the end portion of the grip section 24 on the one side in the longitudinal direction and the locking detection sensor section 32 is, for example, equal to or greater than 30 mm, there can be sufficient reduction in a possibility that the thumb 66a of the occupant or the like will touch the locking detection sensor section 32 when the occupant or the like grips the grip section 24. It is more preferable that the distance L1 between the end portion of the grip section 24 on the one side in the longitudinal direction and the locking detection sensor section 32 is equal to or greater than 40 mm. It is still more preferable that the distance L1 between the end portion of the grip section 24 on the one side in the longitudinal direction and the locking detection sensor section 32 is equal to or greater than 50 mm. The longer the distance L1 between the end portion (boundary between the first section 20 and the second section 22) of the grip section 24 on the one side in the longitudinal direction and the locking detection sensor section 32, the more the reduction in a possibility that the thumb 66a of the occupant or the like will touch the locking detection sensor section 32 when the occupant or the like grips the grip section 24.

The turning shaft inserting hole 26 and the locking detection sensor section 32 may be overlapped in the side view in the normal direction to the surface 30 of the operation handle 12 on the front side. In other words, the turning shaft 64 and the locking detection sensor section 32 may be overlapped in the side view in the normal direction to the surface 30 of the operation handle 12 on the front side. The distance between the end portion (boundary between the first section 20 and the second section 22) of the grip section 24 on the one side in the longitudinal direction and the turning shaft 64 is set to be sufficiently significant. Therefore, when the locking detection sensor section 32 is disposed so as to be overlapped with the turning shaft 64 in the side view in the normal direction to the surface 30 of the operation handle 12 on the front side, it is possible to sufficiently reduce the possibility that the thumb 66a of the occupant or the like will touch the locking detection sensor section 32 when the occupant or the like grips the grip section 24.

A sensor section 38 for pinching is disposed on one side (right-hand side on the paper surface in FIGS. 3A and 3B) of the operation handle 12 in the longitudinal direction. The sensor section for pinching (pinching detection sensor section) 38 is provided to detect pinching when the grip section 24 of the operation handle 12 projects from the accommodation section 18 or when the operation handle 12 is accommodated in the accommodation section 18. It is highly possible that the pinching occurs at the edge of the operation handle 12. Therefore, the pinching detection sensor section 38 is disposed along the edge of the operation handle 12. More specifically, the pinching detection sensor section 38 is disposed along the top surface, the edge surface, and the under surface of the operation handle 12. The pinching detection sensor section 38 is configured to have, for example, a sensor electrode for detecting pinching (pinching detection sensor electrode). Since the pinching detection sensor section 38 is configured to have the pinching detection sensor electrode, the same reference sign 38 is assigned to the pinching detection sensor section and the pinching detection sensor electrode. The pinching detection sensor electrode 38 is electrically connected to the pinching detection sensor (refer to FIG. 1) 40. The pinching detection sensor (pinching detection sensor element) 40 is disposed, for example, in the circuit board 36. As the pinching detection sensor 40, for example, a capacitance type sensor or, more specifically, a self-capacitance type sensor can be used.

When a human appendage or an object does not come into contact with the section in which the pinching detection sensor section 38 is disposed, an output of the pinching detection sensor 40 indicates a state of “non-detection”. When a human appendage or an object comes into contact with the section in which the pinching detection sensor section 38 is disposed, an output of the pinching detection sensor 40 indicates a state of “detection”.

A sensor section 42 for detecting popping up is disposed on the other side (left-hand side on the paper surface in FIGS. 3A and 3B) of the operation handle 12 in the longitudinal direction. The sensor section for detecting popping up (popping-up sensor section) 42 is provided to detect an operation by an occupant or the like, through which the operation handle 12 pops up. The popping-up sensor section 42 is disposed in the second section 22 positioned on the other side (left-hand side on the paper surface in FIGS. 3A and 3B) of the operation handle 12 in the longitudinal direction, that is, in the grip section 24. The popping-up sensor section 42 is disposed on the surface 30 of the operation handle 12 on the front side so as to detect the operation by the occupant or the like. Accordingly, when a part of the hand 66 of the occupant or the like touches the surface 30 of the operation handle 12 on the front side in a section in which the popping-up sensor section 42 is disposed, a popping-up sensor 44 reacts. The popping-up sensor section 42 is configured to have, for example, a sensor electrode for detecting popping up (popping-up detection sensor electrode). Since the popping-up sensor section 42 is configured to have the popping-up sensor electrode, the same reference sign 42 is assigned to the popping-up sensor section and the popping-up sensor electrode. The popping-up sensor electrode 42 is electrically connected to the popping-up sensor 44 (refer to FIG. 1). The popping-up sensor (popping-up sensor element) 44 is disposed, for example, in the circuit board. As the popping-up sensor 44, for example, a capacitance type sensor or, more specifically, a self-capacitance type sensor can be used.

When a human appendage or an object does not come into contact with the surface 30 of the operation handle 12 on the front side in the section in which the popping-up sensor section 42 is set, an output of the popping-up sensor 44 indicates a state of “non-detection”. When a human appendage or an object comes into contact with the surface 30 of the operation handle 12 on the front side in the section in which the popping-up sensor section 42 is set, an output of the popping-up sensor 44 indicates a state of “detection”.

In addition, a sensor section 46 for detecting unlocking is disposed on the other side (left-hand side on the paper surface in FIGS. 3A and 3B) of the operation handle in the longitudinal direction. The sensor section for detecting unlocking (unlocking detection sensor section) 46 is provided to detect an operation by an occupant or the like, through which the opening/closing member 16 enters into an unlocked state (locking-released state). The unlocking detection sensor section 46 is disposed in the second section 22 positioned on the other side (left-hand side on the paper surface in FIGS. 3A and 3B) of the operation handle 12 in the longitudinal direction, that is, in the grip section 24. The unlocking detection sensor section 46 is disposed on a surface 70 of the operation handle 12 on the back side so as to detect the operation by the occupant or the like. Accordingly, when a part of the hand 66 of the occupant or the like touches the surface 70 of the operation handle 12 on the back side in a section in which the unlocking detection sensor section 46 is disposed, an unlocking detection sensor 48 reacts. The unlocking detection sensor section 46 is configured to have, for example, a sensor electrode for detecting unlocking (unlocking detection sensor electrode). Since the unlocking detection sensor section 46 is configured to have the unlocking sensor electrode, the same reference sign 46 is assigned to the unlocking sensor section and the unlocking sensor electrode. The unlocking detection sensor section 46 is electrically connected to the unlocking detection sensor (unlocking detection sensor element) 48. The unlocking detection sensor 48 is disposed, for example, in the circuit board 36. As the unlocking detection sensor 48, for example, a capacitance type sensor or, more specifically, a self-capacitance type sensor can be used.

When a human appendage or an object does not come into contact with the surface 70 of the operation handle 12 on the back side in the section in which the unlocking detection sensor section 46 is set, an output of the unlocking detection sensor 48 indicates a state of “non-detection”. When a human appendage or an object comes into contact with the surface 70 of the operation handle 12 on the back side in the section in which the unlocking detection sensor section 46 is set, an output of the unlocking detection sensor 48 indicates a state of “detection”.

In addition, a pinching detection sensor section 50 is disposed on the other side (left-hand side on the paper surface in FIGS. 3A and 3B) of the operation handle 12 in the longitudinal direction. The pinching detection sensor section 50 is provided to detect pinching when the grip section 24 of the operation handle 12 projects from the accommodation section 18 or when the operation handle 12 is accommodated in the accommodation section 18. As described above, it is highly possible that the pinching occurs at the edge of the operation handle 12. Therefore, the pinching detection sensor section 50 is disposed along the edge of the operation handle 12. The pinching detection sensor section 50 is disposed along the top surface, the edge surface, and the under surface of the operation handle 12. The pinching detection sensor section 50 is configured to have, for example, a sensor electrode for detecting pinching (pinching detection sensor electrode). Since the pinching detection sensor section 50 is configured to have the pinching detection sensor electrode, the same reference sign 50 is assigned to the pinching detection sensor section and the pinching detection sensor electrode. The pinching detection sensor electrode 50 is electrically connected to a pinching detection sensor (refer to FIG. 1) 52. The pinching detection sensor 52 is disposed, for example, in the circuit board 36. As the pinching detection sensor 52, for example, a capacitance type sensor or, more specifically, a self-capacitance type sensor can be used.

When a human appendage or an object does not come into contact with the section in which the pinching detection sensor section 50 is disposed, an output of the pinching detection sensor 52 indicates a state of “non-detection”. When a human appendage or an object comes into contact with the section in which the pinching detection sensor section 50 is disposed, an output of the pinching detection sensor 52 indicates a state of “detection”.

In addition, an antenna 54 is disposed on the other side (left-hand side on the paper surface in FIGS. 3A and 3B) of the operation handle 12 in the longitudinal direction. The antenna 54 can be used to transmit, toward a wireless remote controller, a low frequency (LF) signal for detecting whether or not the wireless remote controller (smart key) (not illustrated) is positioned close to the vehicle 14. Further, the antenna 54 can be used not only to transmit a signal but to receive a signal. The wireless remote controller is used when the locking or unlocking of the opening/closing member 16 is performed from a place separated from the vehicle 14. In addition, the wireless remote controller is used when a locking or unlocking operation of the opening/closing member 16 is performed from a place separated from the vehicle 14. The antenna 54 is electrically connected to a transmission/reception circuit 56 disposed in the circuit board 36.

In addition, an LED 58 is disposed on the other side (left-hand side on the paper surface in FIGS. 3A and 3B) of the operation handle 12 in the longitudinal direction. The LED 58 shows various marks. The LED 58 is electrically connected to an LED driving circuit 60 disposed in the circuit board 36.

As illustrated in FIG. 1, the control unit 62 includes an input unit 72, the central processing unit (CPU) 73, an output unit 74, and a memory 76. The input unit 72, the CPU 73, the output unit 74, and the memory 76 can input and output a signal (data) to and from each other through a bus line 78.

A signal from the locking detection sensor 34 is input to the input unit 72 of the control unit 62. The CPU 73 can detect an operation by an occupant or the like, through which the opening/closing member 16 enters into the locked state, on the basis of the signal from the locking detection sensor 34. In addition, a signal from the popping-up sensor 44 is input to the input unit 72 of the control unit 62. The CPU 73 can detect an operation by an occupant or the like, through which the operation handle 12 enters into a popped-up state, on the basis of the signal from the popping-up sensor 44. In addition, a signal from the unlocking detection sensor 48 is input to the input unit 72 of the control unit 62. The CPU 73 can detect an operation by an occupant or the like, through which the opening/closing member 16 enters into the unlocked state, on the basis of a signal from the unlocking detection sensor 48. In addition, signals from the pinching detection sensors 40 and 52 are input to the input unit 72 of the control unit 62. The CPU 73 can detect the occurrence of pinching on the basis of signals from the pinching detection sensors 40 and 52. In addition, a signal from the transmission/reception circuit 56 is input to the input unit 72 of the control unit 62. The CPU 73 can detect details of an operation performed by using the wireless remote controller, on the basis of a signal from the transmission/reception circuit 56.

The transmission/reception circuit 56 is connected to the output unit 74 of the control unit 62. The CPU 73 controls the transmission/reception circuit 56 through the output unit 74, thereby making it possible to transmit a signal from the antenna 54 to the wireless remote controller. In addition, the LED driving circuit 60 is connected to the output unit 74 of the control unit 62. The CPU 73 can control the LED 58 through the output unit 74 and the LED driving circuit 60 such that the LED shows a mark. In addition, a motor (door locking mechanism motor) 80 which drives a door locking mechanism 82 is connected to the output unit 74 of the control unit 62. The door locking mechanism 82 performs locking and unlocking of the opening/closing member 16. The CPU 73 drives the door locking mechanism 82 through the output unit 74 such that the door locking mechanism motor 80 rotates, thereby making it possible for the opening/closing member 16 to enter into the locked state or the unlocked state. In addition, a motor (opening/closing motor) 88, which drives an opening/closing actuator (opening/closing mechanism) 90 provided with respect to the opening/closing member 16, is connected to the output unit 74 of the control unit 62. The CPU 73 drives the opening/closing mechanism 90 by causing the opening/closing motor 88 to rotate through the output unit 74, thereby making it possible to perform opening and closing of the opening/closing member 16. In addition, a motor (popping-up motor) 83, which drives a popping-up actuator 84, is connected to the output unit 74 of the control unit 62. The CPU 73 drives the popping-up actuator 84 by causing the popping-up motor 83 to rotate through the output unit 74, thereby making it possible for the grip section 24 of the operation handle 12 to project from the accommodation section 18, and making it possible for the operation handle 12 to be accommodated in the accommodation section 18.

Next, an operation of the opening/closing member opening/closing apparatus according to the embodiment will be described with reference to the drawings.

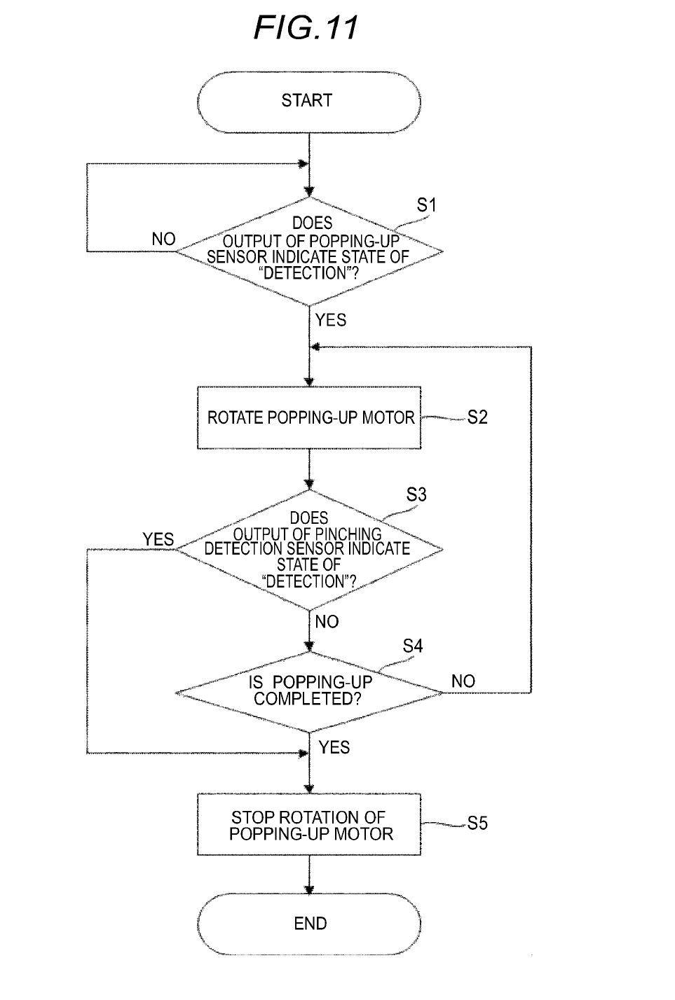

First, an operation performed when the operation handle 12 is caused to pop up will be described with reference to FIG. 11. FIG. 11 is a flowchart illustrating the operation of the opening/closing member opening/closing apparatus according to the embodiment.

The operation handle 12 is accommodated in the accommodation section 18. The CPU 73 checks whether or not the output of the popping-up sensor 44 indicates the state of “detection” (Step 51). In a case where the output of the popping-up sensor 44 indicates the state of “non-detection” (NO in Step S1), it is considered that an occupant or the like does not try to pop up the operation handle 12. Accordingly, in this case, the CPU 73 does not cause the popping-up motor 83 to rotate. When a part of the hand 66 of the occupant or the like touches the surface 30 of the operation handle 12 on the front side in the section in which the popping-up sensor section 42 is set, the output of the popping-up sensor 44 indicates the state of “detection”. In a case where the output of the popping-up sensor 44 indicates the state of “detection” (YES in Step S1), it is considered that an occupant or the like tries to pop up the operation handle 12. Accordingly, in this case, the CPU 73 causes the popping-up motor 83 to rotate (Step S2). When the popping-up motor 83 is caused to rotate, the popping-up actuator 84 is driven and the operation handle 12 turns.

In a procedure of turning the operation handle 12, the CPU 73 checks whether or not the outputs of the pinching detection sensors 40 and 52 indicate the state of “detection” (Step S3). In a case where the outputs of the pinching detection sensors 40 and 52 indicate the state of “non-detection” (NO in Step S3) and the popping-up is not completed (NO in Step S4), the CPU 73 continue to rotate the popping-up motor (Step S2). In a case where the outputs of the pinching detection sensors 40 and 52 indicate the state of “detection” (YES in Step S3), it is considered that the pinching occurs. Therefore, the CPU 73 stops rotating the popping-up motor 83 (Step S5). In addition, in a case where the popping-up is completed (YES in Step S4), the CPU 73 stops rotating the popping-up motor 83 (Step S5). Thus, the popping-up of the operation handle 12 is performed.

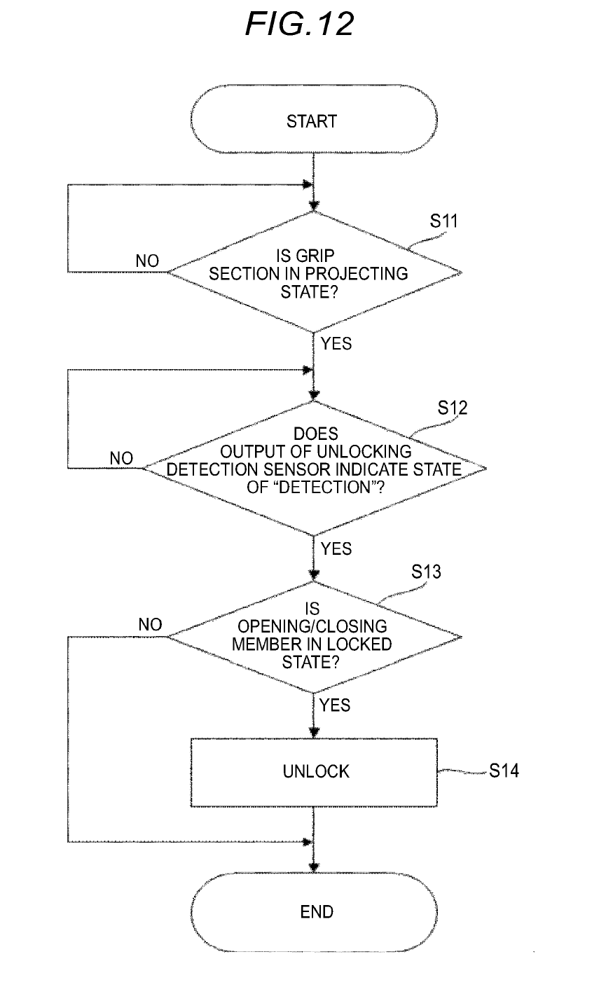

Next, another operation performed when the lock of the opening/closing member 16 is released, that is, when the opening/closing member 16 enters into the unlocked state, will be described with reference to FIG. 12. FIG. 12 is a flowchart illustrating the operation of the opening/closing member opening/closing apparatus according to the embodiment.

In a case where the grip section 24 of the operation handle 12 is accommodated in the accommodation section 18 (NO in Step S11), the CPU 73 does not cause the process to proceed to a step (Step S12) in which the output of the unlocking detection sensor 48 is checked. In a case where the grip section 24 of the operation handle 12 projects from the accommodation section 18 (YES in Step S11), the CPU 73 checks whether or not the output of the unlocking detection sensor 48 indicates the state of “detection” (Step S12). In a case where the output of the unlocking detection sensor 48 indicates the state of “non-detection” (NO in Step S12), the CPU 73 does not cause the process to proceed to a step (Step S13) in which the locked state of the opening/closing member 16 is checked.

An occupant or the like grips the grip section 24 of the operation handle 12 and touch the surface 70 of the operation handle 12 on the back side in the grip section 24, thereby performing an operation for releasing the lock. When a part of the hand 66 of the occupant or the like touches the surface 30 of the operation handle 12 on the front side in the section in which the unlocking detection sensor section 46 is set, the output of the unlocking detection sensor 48 indicates the state of “detection”. In a case where the output of the unlocking detection sensor 48 indicates the state of “detection” (YES in Step S12), the CPU 73 checks whether or not the opening/closing member 16 is in the locked state (Step S13). In a case where the opening/closing member 16 is not in the locked state (NO in Step S13), the lock is already released and the opening/closing member is in the unlocked state. Therefore, an operation of unlocking is not further operated. In a case where the opening/closing member 16 is in the locked state (YES in Step S13), the CPU 73 drives the door locking mechanism 82 by causing the door locking mechanism motor 80 to rotate and causes the opening/closing member 16 to enter into the unlocked state (Step S14). Thus, the unlocking of the opening/closing member 16 is performed.

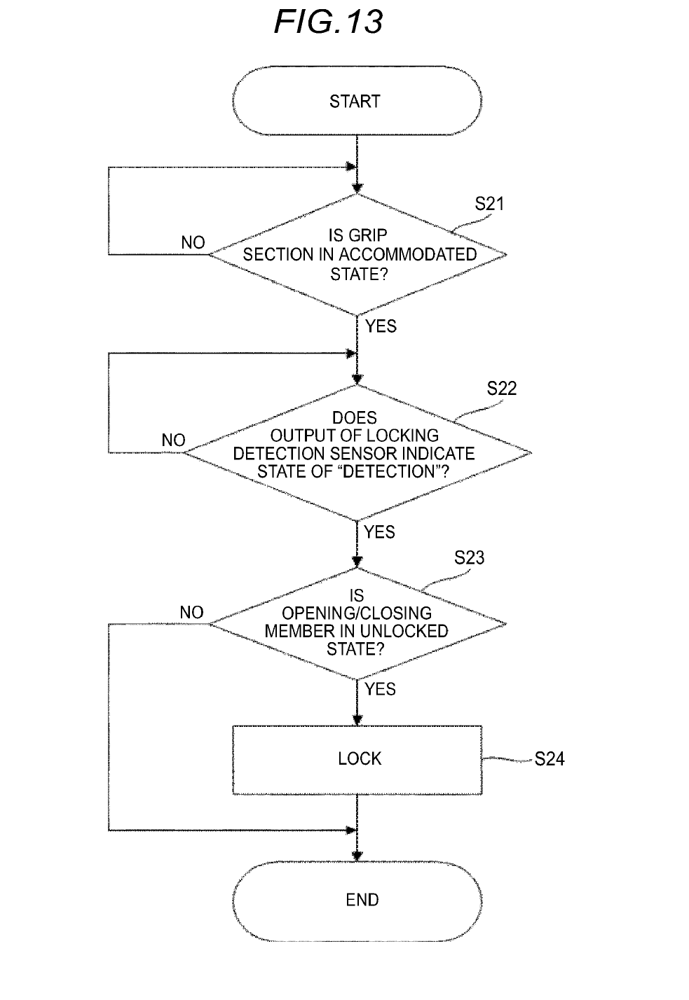

Next, still another operation performed when the opening/closing member 16 is in the locked state will be described with reference to FIG. 13. FIG. 13 is a flowchart illustrating the operation of the opening/closing member opening/closing apparatus according to the embodiment.

In a case where the grip section 24 of the operation handle 12 projects from the accommodation section 18 (NO in Step S21), the CPU 73 does not cause the process to proceed to a step (Step S22) in which the output of the unlocking detection sensor 48 is checked. In a case where the grip section 24 of the operation handle 12 is accommodated in the accommodation section 18 (YES in Step S21), the CPU 73 checks whether or not the output of the locking detection sensor 34 indicates the state of “detection” (Step S22). In a case where the output of the locking detection sensor 34 indicates the state of “non-detection” (NO in Step S22), the CPU 73 does not cause the process to proceed to a step (Step S23) in which it is checked whether or not the opening/closing member 16 is in the unlocked state.

When a part of the hand 66 of the occupant or the like touches the surface 30 of the operation handle 12 on the front side in the section in which the locking detection sensor section 32 is set, the output of the locking detection sensor 34 indicates the state of “detection”. In a case where the output of the locking detection sensor 34 indicates the state of “detection” (YES in Step S22), the CPU 73 checks whether or not the opening/closing member 16 is in the unlocked state (Step S23). In a case where the opening/closing member 16 is not in the unlocked state (NO in Step S23), the lock is already released and the operation of the locking is not further performed. In a case where the opening/closing member 16 is in the unlocked state (YES in Step S23), the CPU 73 drives the door locking mechanism 82 by causing the door locking mechanism motor 80 to rotate and causes the opening/closing member 16 to enter into the locked state (Step S24). Thus, the locking of the opening/closing member 16 is performed.

In this manner, according to the embodiment, the unlocking detection sensor section 46 is disposed in the grip section 24, the locking detection sensor section 32 is not overlapped with the grip section 24 in the side view in the normal direction to the surface 30 of the operation handle 12 on the front side. Therefore, when the occupant or the like performs the operation for the unlocked state, it is possible to prevent a part of the hand 66 of the occupant or the like from touching the locking detection sensor section 32. Accordingly, it is possible to provide the opening/closing member opening/closing apparatus which can prevent an incorrect operation.

In addition, according to the embodiment, the locking detection sensor section 32 is disposed on the surface 30 of the operation handle 12 on the front side and the unlocking detection sensor section 46 is positioned on the surface 70 of the operation handle 12 on the back side. Therefore, when the occupant or the like performs the operation for the locked state, the hand 66 of the occupant or the like does not touch the unlocking detection sensor section 46. Accordingly, according to the embodiment, it is possible to provide the opening/closing member opening/closing apparatus which can prevent an incorrect operation.

Moreover, according to the embodiment, when the operation handle 12 is accommodated in the accommodation section 18, the surface 30 of the operation handle 12 on the front side is positioned substantially as an extended surface of the surface of the opening/closing member 16 on the front side. Therefore, it is possible to realize the flush surface, thereby making it possible to provide the vehicle 14 which is good in designability.

### Modification Example 1

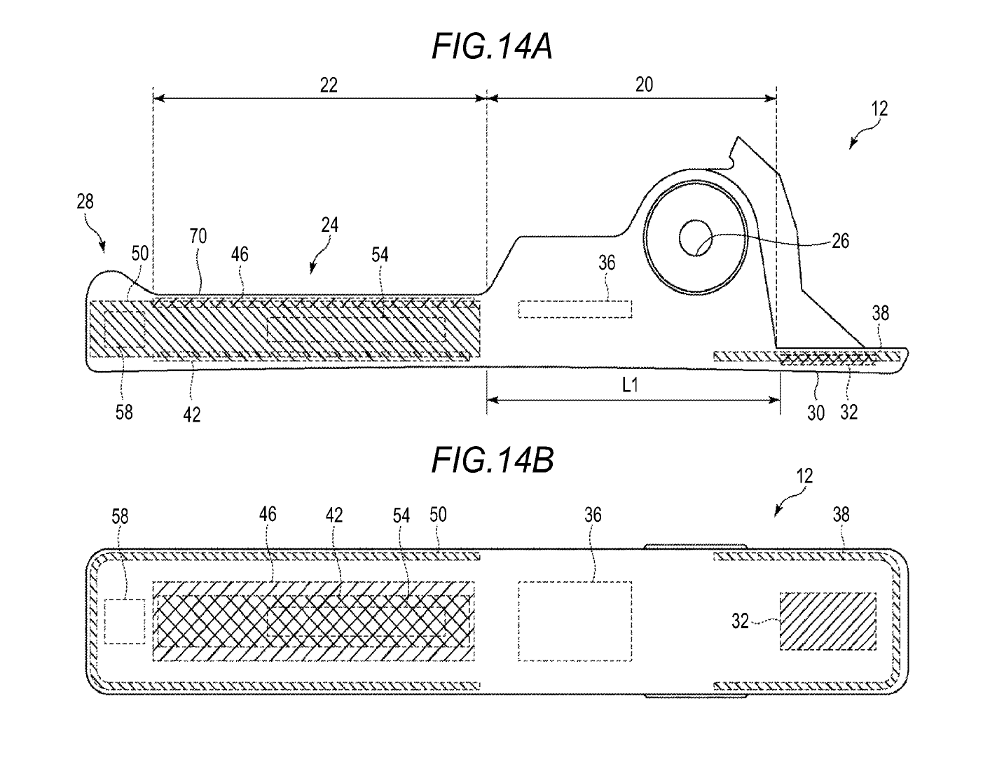

Next, a modification example of the opening/closing member opening/closing apparatus according to the embodiment will be described with reference to FIGS. 14A and 14B. FIGS. 14A and 14B are a plan view and a side view illustrating an operation handle of an opening/closing member opening/closing apparatus according to the modification example; FIG. 14A is the plan view and FIG. 14B is the side view.

When the grip section 24 of the operation handle 12 projects from the accommodation section 18, the operation handle of the opening/closing member opening/closing apparatus of the modification example sets the position of the locking detection sensor section 32 such that at least a part of the locking detection sensor section 32 is positioned in the accommodation section 18.

As illustrated in FIGS. 14A and 14B, in the modification example, the locking detection sensor section 32 is disposed in the vicinity of the end portion of the operation handle 12 on the one side (right-hand side on the paper surface in FIGS. 14A and 14B) in the longitudinal direction. Therefore, in the modification example, when the grip section 24 of the operation handle 12 projects from the accommodation section 18, at least a part of the locking detection sensor section 32 is positioned in the accommodation section 18.

The portion of the operation handle 12, which is accommodated in the accommodation section 18 when the grip section 24 projects from the accommodation section 18, is sufficiently separated from the end portion (boundary between the first section 20 and the second section 22) of the grip section 24 on the one side in the longitudinal direction. In addition, a part of the hand 66 of the occupant or the like is unlikely to touch the portion of the operation handle 12, which is positioned in the accommodation section 18 when the grip section 24 projects from the accommodation section 18. Accordingly, when the locking detection sensor section 32 is disposed in this manner, a part of the hand 66 of the occupant or the like is unlikely to touch the locking detection sensor section 32. Accordingly, it is possible to reliably prevent the locking detection sensor section 32 from being touched by the hand 66 of the occupant or the like.

In this manner, when the grip section 24 of the operation handle 12 projects from the accommodation section 18, at least a part of the locking detection sensor section 32 may be positioned in the accommodation section 18.

### Modification Example 2

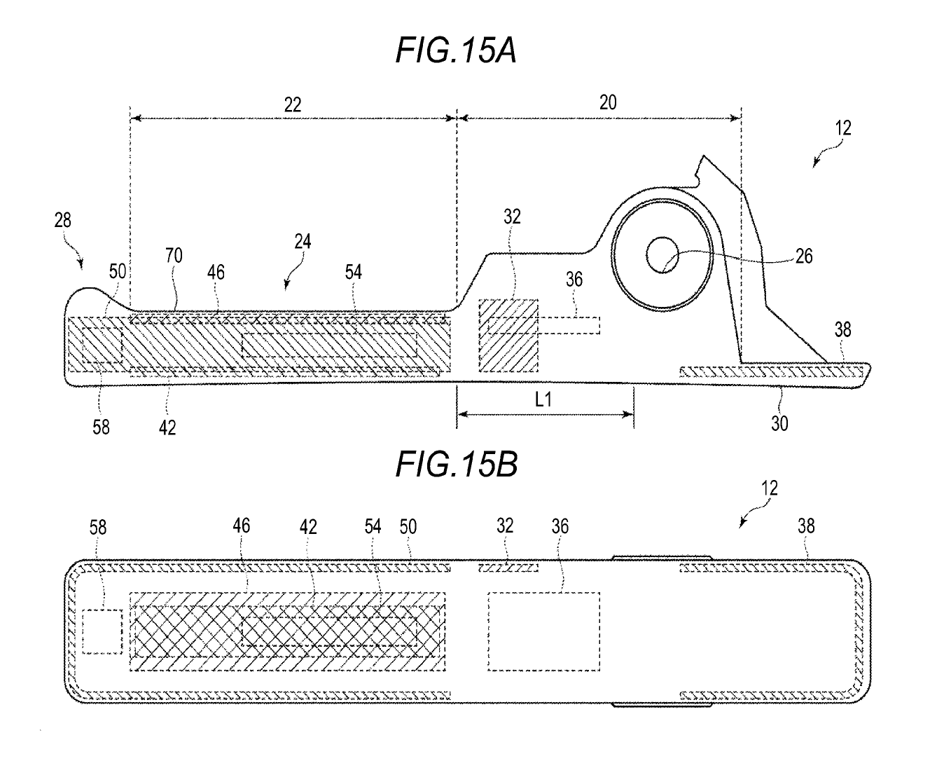

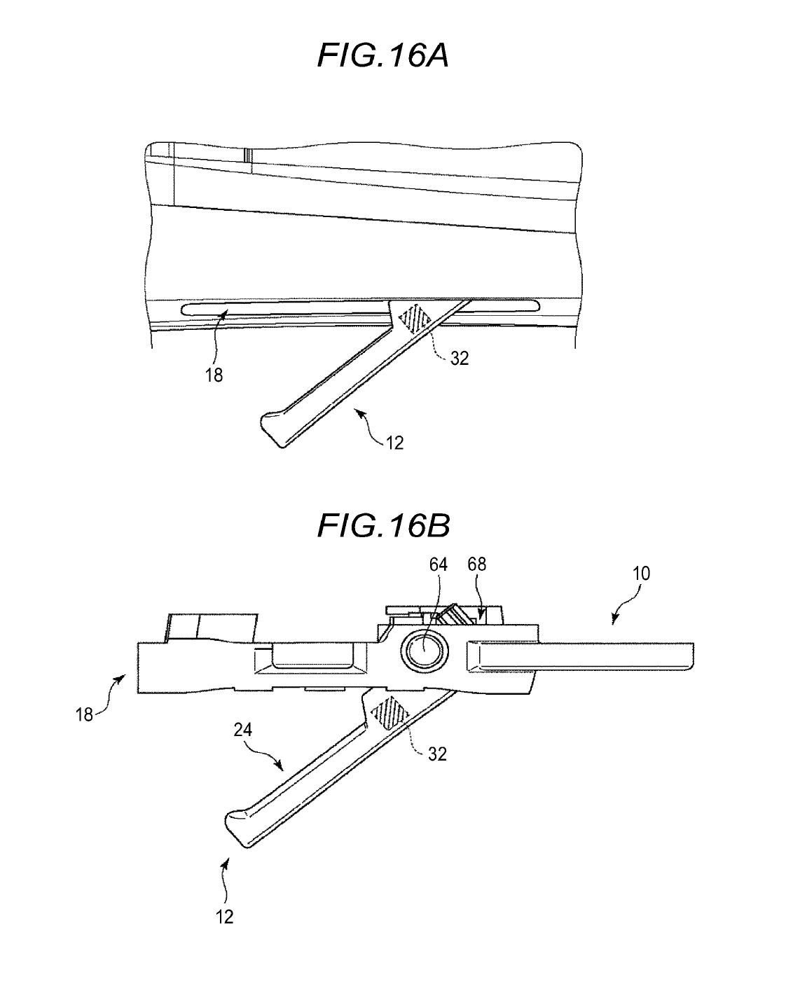

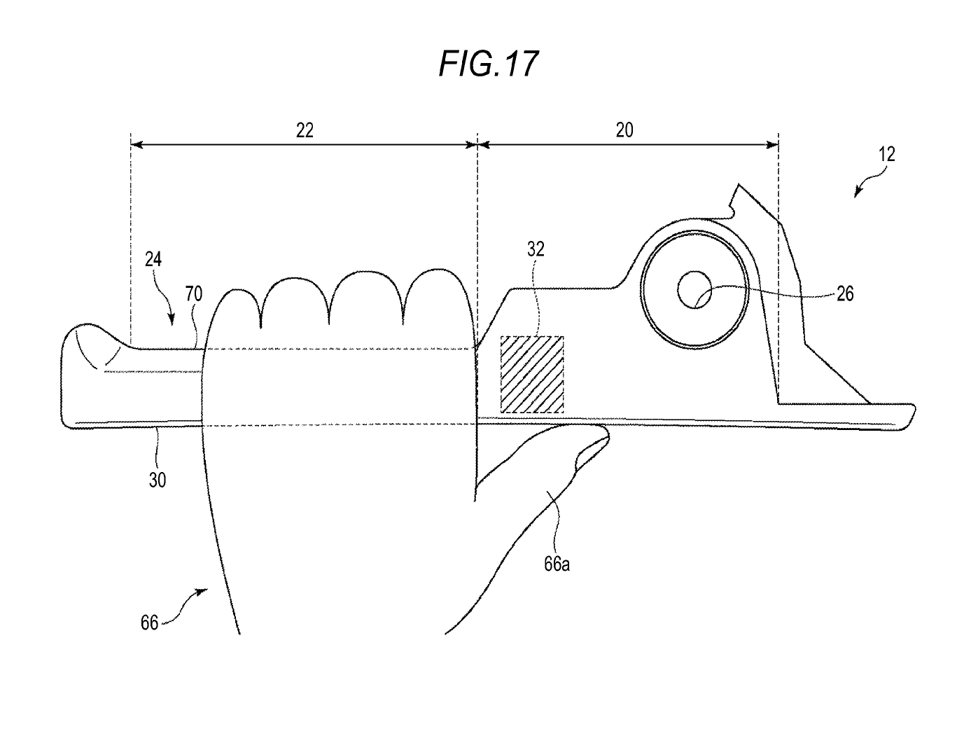

Next, another modification example of the opening/closing member opening/closing apparatus according to the embodiment will be described with reference to FIGS. 15A to 17. FIGS. 15A and 15B are a plan view and a side view illustrating an operation handle of an opening/closing member opening/closing apparatus according to the modification example; FIG. 15A is the plan view and FIG. 15B is the side view. FIGS. 16A and 16B are plan views illustrating a state in which the grip section of the operation handle projects from the accommodation section; FIG. 16A illustrates a state in which the opening/closing member opening/closing apparatus according to the modification example is attached to the vehicle and FIG. 16B illustrates a state in which the base member and the operation handle of the opening/closing member opening/closing apparatus according to the modification example. FIG. 17 is a plan view illustrating a state in which the grip section of the operation handle is gripped by an occupant or the like.

As illustrated in FIG. 15A, in the opening/closing member opening/closing apparatus according to the modification example, the locking detection sensor section 32 is disposed on the upper side of the first section 20. Specifically, as illustrated in FIGS. 16A and 16B, the locking detection sensor section 32 is disposed on the upper side of the first section 20 in a portion disposed on the outer side of the accommodation section 18 when the operation handle 12 pops up. When a human appendage or an object comes into contact with the surface of the first section 20 on the upper surface side in the portion in which the locking detection sensor section 32 is set, the output of the locking detection sensor 34 indicates the state of “detection”.

Since the locking detection sensor section 32 is disposed on the upper side of the first section 20, a part of the hand 66 of the occupant or the like does not touch the locking detection sensor section 32 when the occupant or the like grips the grip section 24 (refer to FIG. 17). Accordingly, according to the modification example, it is possible to reliably prevent the hand 66 of the occupant or the like from touching the locking detection sensor section 32 by error.

### Modified Embodiment

Various modifications can be performed without limiting to the embodiment described above.

For example, in the embodiment described above, the case where a self-capacitance type sensor is used as the sensors 34, 40, 44, 48, and 52 is described as an example; however, the sensors are not limited thereto. For example, as the sensors 34, 40, 44, 48, and 52, a mutual capacitance type sensor may be used.

In addition, in the embodiment described above, the case where a capacitance type sensor is used as the sensors 34, 40, 44, 48, and 52 is described as an example; however, the sensors are not limited thereto. For example, as the sensors 34, 40, 44, 48, and 52, a piezoelectric element or the like may be used.

In addition, in the embodiment described above, the case where the sensor sections 32, 38, 42, 46, and 50 are configured to have a sensor electrode is described as an example; however, the sensors are not limited thereto. For example, a sensor element may be disposed in the sensor sections 32, 38, 42, 46, and 50.

In addition, in the embodiment described above, the case where the sensor sections 32, 38, 42, 46, and 50 are configured to have a sensor electrode is described as an example; however, the sensors are not limited thereto. For example, as the sensor sections 32, 38, 42, 46, and 50, a push-button switch, or the like may be used.

In addition, in the embodiment described above, the case where the contact sensor is used as the sensors 34, 40, 44, 48, and 52 is described as an example; however, the sensors are not limited thereto. For example, as the sensors 34, 40, 44, 48, and 52, a proximity sensor may be used. In addition, as the sensors 34, 40, 44, 48, and 52, an infrared sensor, an ultrasonic sensor, or the like may be used.

In addition, in the embodiment described above, the state in which the circuit board 36 is accommodated in the portion between the grip section 24 and the locking detection sensor section 32 is described as an example; however, a place in which the circuit board 36 is accommodated is not limited to the portion between the grip section 24 and the locking detection sensor section 32. For example, the circuit board 36 may be accommodated in the operation handle 12 in the vicinity of the end portion of the operation handle 12 on the one side (right-hand side on the paper surface in FIGS. 3A and 3B) in the longitudinal direction.

In addition, an obstacle detecting sensor section may be further provided on the surface 30 of the operation handle 12 on the front side.

In addition, the case in which the popping-up motor 83 is caused to rotate such that the popping-up actuator 84 is driven is described as an example; however, the driving is not limited thereto. For example, as the popping-up actuator 84, a hydraulic actuator or a pneumatic actuator may be used.

In addition, a switch or a sensor for monitoring a state of the operation handle 12 may be provided in the operation handle 12 or on the periphery of the operation handle 12.

According to the aspect of this disclosure, the first sensor section detects the operation, through which the opening/closing member enters into the unlocked state, and is disposed in the grip section, and the second sensor section detects the operation through which the opening/closing member enters into the locked state and is not overlapped with the grip section in the side view in the normal direction to the surface on the front side of the operation handle. Hence, according to this disclosure, when an occupant or the like performs the operation for the unlocked state, it is possible to prevent the second sensor section from being touched with a hand by the occupant or the like. Therefore, according to this disclosure, there can be provided an opening/closing member opening/closing apparatus which can prevent an incorrect operation.

The principles, preferred embodiment and mode of operation of the present invention have been described in the foregoing specification. However, the invention which is intended to be protected is not to be construed as limited to the particular embodiments disclosed. Further, the embodiments described herein are to be regarded as illustrative rather than restrictive. Variations and changes may be made by others, and equivalents employed, without departing from the spirit of the present invention. Accordingly, it is expressly intended that all such variations, changes and equivalents which fall within the spirit and scope of the present invention as defined in the claims, be embraced thereby.

What is claimed is:

1. An opening/closing member opening/closing apparatus comprising:
an operation handle that includes a first section, which is thick in a normal direction to a surface on the front side and in which a turning shaft is disposed, and a grip section formed of a second section which is thinner than the first section in the normal direction to the surface on the front side, that is configured to be supported in a turning manner by a base member disposed in an opening/closing member, and that is able to shift between an accommodated position, at which the grip section is in a state of being accommodated in an accommodation section formed in the base member, and a projecting position, at which the grip section is in a state of projecting from the accommodation section;
a first sensor section that detects an operation through which the opening/closing member enters into an unlocked state and that is disposed in the grip section; and
a second sensor section that detects an operation through which the opening/closing member enters into a locked state and that is disposed in the operation handle so as not to be overlapped with the grip section in a side view in the normal direction to the surface on the front side of the operation handle.

2. The opening/closing member opening/closing apparatus according to claim 1,
wherein the distance between a boundary between the grip section and the first section, and the second sensor section is equal to or greater than 30 mm.

3. The opening/closing member opening/closing apparatus according to claim 1,
wherein at least a part of the second sensor section and the turning shaft are overlapped in the side view from the surface on the front side of the operation handle.

4. The opening/closing member opening/closing apparatus according to claim 1,
wherein, when the operation handle is set at the projecting position, at least a part of the second sensor section is positioned in the accommodation section.

5. The opening/closing member opening/closing apparatus according to claim 1,
wherein a circuit board is accommodated between the boundary between the grip section and the first section, and the second sensor section.

6. The opening/closing member opening/closing apparatus according to claim 1,
wherein the second sensor section is positioned on the upper side of the first section.

7. The opening/closing member opening/closing apparatus according to claim 1,
wherein the first sensor section is disposed in the grip section on a surface on the back side of the operation handle.

8. The opening/closing member opening/closing apparatus according to claim 1, further comprising:
a central processing unit that sets the opening/closing member to the unlocked state on the basis of a first signal in response to detection by the first sensor section and sets the opening/closing member to the locked state on the basis of a second signal in response to detection by the second sensor section.
